(19) United States
(12) Patent Application Publication
(10) Pub. No.: US 2013/0146686 A1
(43) Pub. Date: Jun. 13, 2013

(54) METHOD AND INSTALLATION FOR COAL GRINDING IN INERT OPERATION OR IN NON-INERT OPERATION

(71) Applicants: Silke Schlegel, Aachen (DE); Gerhard Salewski, Essen (DE); Juergen Woelk, Huenxe (DE)

(72) Inventors: Silke Schlegel, Aachen (DE); Gerhard Salewski, Essen (DE); Juergen Woelk, Huenxe (DE)

(73) Assignee: LOESCHE GMBH, Duesseldorf (DE)

(21) Appl. No.: 13/639,155

(22) PCT Filed: Aug. 23, 2011
(86) PCT No.: PCT/EP2011/004233

§ 371 Date: Dec. 19, 2012

(30) Foreign Application Priority Data
Sep. 2, 2010 (DE) 10 2010 036 176.3

(51) Int. Cl. B02C 23/08; B02C 23/34

(52) U.S. Cl. CPC B02C 23/08; B02C 23/34
USPC 241/17; 241/47

(57) ABSTRACT

The invention relates to a method and an installation for coal grinding in inert operation or in non-inert operation, wherein a proportion of the coal dust produced in a mill is fed to a classifier for separation of super fines. The super fines are fed to a hot gas generator with solid fuel burner in order to heat the re-circulated process gas and to feed it back to the mill. The self-produced coal dust is thus used for the hot gas generation.

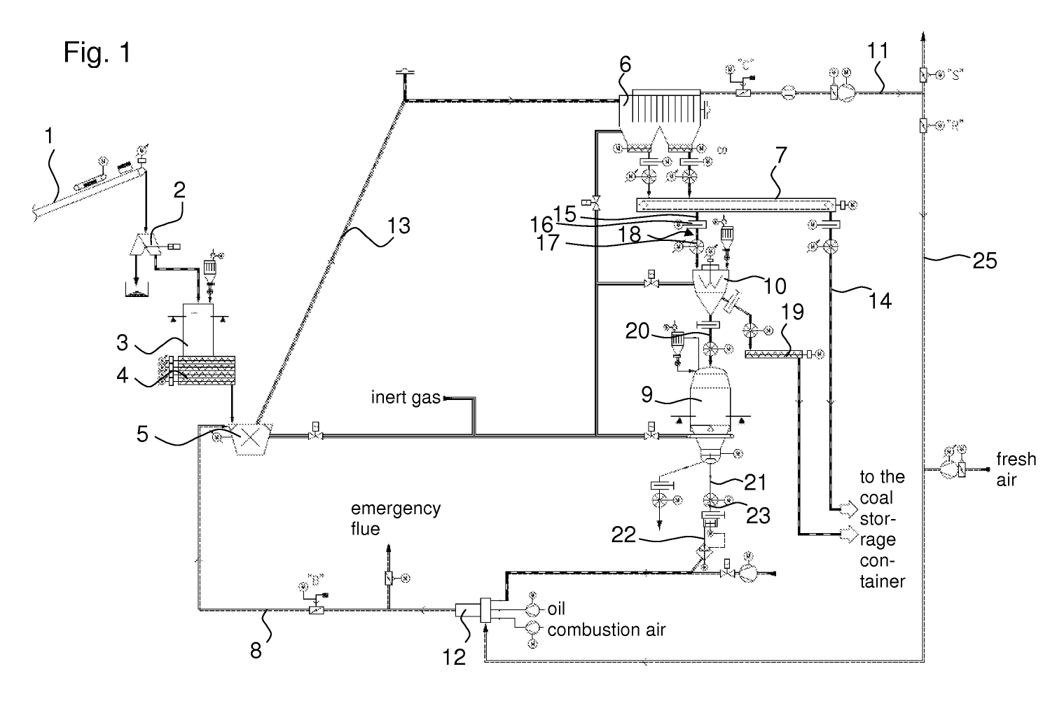

The invention relates to a method for coal grinding in inert operation or in non-inert operation according to claim 1 and to an installation for coal grinding in inert operation or in non-inert operation according to claim 9.

The invention is suitable in principle for all coal grinding plants, in which raw coal is ground to coal dust in inert operation or in air driven operation. Coal grinding installations are used in different branches of industry, for example in installations for hot gas generation, fluidised bed combustion and in coal gasification plants. Coal grinding is also carried out in the cement industry in the production of cement and in the steel and smelting industry and in non-ferrous metallurgical processes which comprise PCI (Pulverised Coal Injection) installations.

Methods and installations for coal grinding are described in the prior art of DE 10 2005 040 519 B4, which is orientated towards a method and a device for grinding and simultaneous drying of hot and wet raw materials, in particular cement clinker, slag and aggregates. DE 30 06 470 A1 relates to a device for operating a coal grinding and drying installation using a ball or roller mill and inert hot gases from a hot gas generator and EP 0 579 214 A1 relates to a grinding—drying process for raw brown coal in an air swept roller mill with the supply of cold gas, in particular cold and/or ambient air. DE 36 39 206 C1 discloses a method for regulating a bowl roller mill for producing coal dust for coal dust firing and U.S. Pat. No. 4,597,537 A describes a vertical mill which can be used inter alia for coal grinding and is orientated towards the improvement of the classifying process.

In addition the method and the installation can be used for novel power station technologies, such as for example the oxycoal process. The method and the installation are also suitable for the operation of hot gas generators and for briquette production.

In order to produce coal briquettes so-called “young coals”, that is to say soft brown coals, hard brown coals and sub-bituminous coals with a water content of from approximately 10% to approximately 75% and a proportion of volatile components of from approximately 35% to approximately 60% (i.waf) are generally used.

In a known method for briquette production (VORWEG GEHEN—RWE-POWER; PHV-SU) previously broken-up raw coal is reduced after preliminary screening in a hammer mill and then subjected to further screening. The wet material passes on a fine coal conveyor via a bunker to a tubular dryer. The dried fines are subsequently fed to a briquetting press. The coal portions separated in the preliminary and further screening are used as boiler coal in a power station. A disadvantage is to be seen in the drying of the fine coal after the coal grinding with the aid of an external energy carrier and the necessary screenings.

A binderless briquetting method is known from WO 90/10052, wherein already reduced, wet fine coal is fed with the aid of a feed conveyor belt together with already dried fine coal and previously heated fine material from a separator to a briquetting press above a gas mixing chamber of a hot gas generator and then fed to an entrained flow drying tube or flash-dryer tube respectively and heated in a reducing or respectively inert atmosphere to 25° to 200° C. After a cyclone, in which the fine coal is separated, it is then fed via a feed compressor to the briquetting press. The inert gas is fed proportionally as return gas to the gas mixing chamber and to the burner of the hot gas generator. The whole installation is operated at an overpressure and a heat exchange takes place between the briquettes or reduced briquettes with the wet fine material before drying in the entrained flow drying tube.

In a Powerpoint presentation the aforementioned BCB process (Binderless Coal Briquetting Process) is modified in that the fine coal dried in the entrained flow dryer tube or respectively flash-dryer tube supplied by the hot gas generator is separated in a cyclone battery into a coarser, briquettable particle size range and into a fine material. The dry gas is removed. The fine material is fed to the burner of the hot gas generator as a fuel under overpressure and the hot gases produced in the hot gas generator reach the entrained flow dryer tube. No assertions are made concerning the particle size of the fine material and a super fines portion. The proportion of super fines or respectively the grain structure has an effect, however, upon the density, compressability, etc. and can considerably reduce the quality of the briquettes produced therefrom.

It is an object of the invention to create a method and an installation for coal grinding in inert or air driven operation which guarantee in an energy efficient manner the provision of coal dust in a particle size corresponding to the respective use and simultaneously the production of hot gases for the grinding—drying process.

In terms of the method the object is achieved through the features of claim 1 and in terms of the device through the features of claim 9.

Useful and advantageous embodiments are contained in the sub-claims and follow from the description of the figures.

A core idea of the invention can be seen in that coal dust produced in a grinding—drying process and separated in a separating unit from the drying and carrier gases is fed at least proportionally to a classifier in order to separate ultra fine dust or respectively a super fines portion from the coal dust as the ground product through classification and then to use this super fines portion for the provision of the necessary heat for the grinding—drying process and thus to save other energy carriers, in particular premium energy carriers such as natural gases, oils, synthesis gases.

Through the arrangement of a classifier means after the separating unit this subsequent classifying process is decoupled from the gas conveying process, in particular in the mill and in the separating unit. The decoupling of the classifying process from the gas conveying process is advantageous particularly having regard to safety.

According to the invention the super fines portion separated in a static or respectively mechanical classifier from the ground product is used for combustion in a hot gas generator for solid fuels in order to provide the drying energy required for the grinding—drying process.

Insofar as a super fines portion is purposefully removed from the coal dust as a ground product and corresponding to the requirements is fed at least proportionally to a hot gas generator with a solid fuel burner for combustion, with the coarser coal dust arising in the classifier a coal dust portion is available, which no longer has the disadvantageous super fines portion which generally impairs the use and further processing, for example briquetting.

In particular according to the invention the fuel is removed in an extraordinarily efficient manner to produce the hot drying and carrier gases required in the grinding—drying process directly from the grinding—drying circuit. A separate fuel supply from externally, which requires additional transport and/or storage means, is avoided. As the super fine coal from the process of coal grinding itself is used in the hot gas generator the pre-drying and preparation of external coal necessary in an external fuel supply can also be omitted, which leads to a lower energy requirement.

It is advantageous that the micro fines portion of the coal dust separated according to the invention in the mechanical or static classifier can be separated with a particle size required for a solid fuel burner of a hot gas generator.

The particle size of the coal dust fines fed to the solid fuel burner of a hot gas generator generally amounts to approximately 10% R90 μm.

In principle the use of solid fuels in a hot gas generator is determined by the parameters granulation structure, volatile components content and ash content of the brown coals or hard coals used. The lower the proportion of volatile components the finer the coal dust must be ground. High ash contents, for example up to 45%, can lead to complications in the combustion process on account of the associated lower calorific value. Measures must therefore be taken for a corresponding flame formation.

It is useful if the micro fines portion separated in the classifier has a fineness in the range of from approximately 50% R90 μm to approximately 1% R90 μm.

It has been found that a further important value is the d₅₀ value which should amount to 10 to 30 μm at a content of volatile components in the coal of from approximately 25 to 30%. In case of a higher proportion of volatile components the grain distribution can be coarser.

Hot gas generators with a solid fuel burner which is fired with dust-form fuels and is also described as a dust burner are known and described for example in DE 197 06 077 A1 and DE 197 25 613 A1.

DE 102 32 373 B4 discloses a hot gas generator, in which coal dust, for example brown coal dust, is combusted. The coal dust having been mixed with combustion air is supplied in fluidised form in order to generate hot gases from 200° C. to 900° C.

It is advantageous that the coal dust micro fines can be fed to a coal dust burner of a hot gas generator with a burner quarl and a subsequent perforated jacket. The perforated jacket consists of a plurality of perforated sheet cylinder portions. The gas arising in the separating unit is fed as return gas at about 100° C. to the hot gas generator and passes via an annular channel of the perforated jacket and via annular openings and holes in the perforated jacket (LOMA) (LOMA is a trademark of LOESCHE) into the flue gas stream of the (LOMA) perforated jacket combustion chamber (DE 197 06 077 A1) and can be heated to a temperature in the range of from 150° C. to over 700° C. The use of a (LOMA) perforated jacket combustion chamber with a solid fuel burner guarantees the compliance with the legally prescribed threshold values for CO and NOₓ in the gases discharged proportionally to the environment.

In principle all classifiers which supply the necessary grain spectrum of the super fines for a hot gas generator with solid fuel burner are suitable for the inventive separation of the fines portion from the ground material of the grinding—drying process.

A static or mechanical classifier, wherein a secondary circuit is avoided, can preferably be used having regard to safety aspects. For example the gearless mechanical separator, which is described in BULLETIN 774 R of the Williams Patent Crusher & Pulverizer Company, USA and in U.S. Pat. No. 2,913,109 A, is suitable. Fan blades rotate in a closed classifying chamber and produce a rising air flow, in which the fine material, separated by means of rotating classifying vanes, of the classifying material fed from above onto a distributor plate is carried upwards and falls downwards to a fine material outlet on the outer housing wall while the coarse grain freed from the fine material passes downwards to a coarse material outlet. For this classifier merely a small sealing air fan is necessary. The possible setting of a desired particle size of the fine material with the aid of an adjustable opening of the inner housing and via the speed of the fan blades, the classifier vanes and the distributor plate is advantageous. Depending upon the type of coal the classification can thus be adjusted corresponding to the requirements upon the desired particle size of the micro fines of the coal dust.

In terms of the device the object is achieved through an installation for coal grinding in inert operation or in non-inert operation with a mill for carrying out a grinding—drying process and production of coal dust as well as with a separating unit for separating the coal dust from the gas and with a hot gas generator with solid fuel burner for heating the return gas and producing hot gases for the grinding—drying process in that a classifier for the separation of super fines from the coal dust as well as a silo for receiving the separated super fines and a connecting line with a removal means and a dosing means for the super fines for supply to the solid fuel burner of the hot gas generator are disposed after the separating unit.

The type of mill used for the grinding of the wet raw coal which is generally previously broken up is an air swept mill, in which the grinding—drying process can be carried out. It is possible to use for example roller mills, pendulum roller mills, hammer mills and ball-and-race mills. Preferably a hammer mill can be used if a product with a larger particle size is desired, which is advantageous for example in briquette production. If a finer material is required, for example for PCI plants, coal gasification plants and for the operation of hot gas generators, vertical air swept roller mills are advantageous as they can grind the coals to <30% R90 μm.

As a separating unit for separating the ground product or the coal dust from the carrier gas a filter, for example a bag filter, can be used or also a cyclone or respectively a cyclone battery can be used. By means of a rotary feeder and a corresponding transport means a defined portion of the coal dust arising in the separating unit can be fed to the classifier for separation of the super fines for the hot gas generator.

The coal dust not fed to the classifier passes via a conveying means to the intended place of use or for further processing, for example to a briquetting press, a PCI installation or for coal gasification.

The inventive method and the inventive installation can be used in coal gasification plants, PCI plants in the steel and smelting industry and in non-ferrous metallurgical processes as well as in general heat-based installations. The synthesis gas produced in the coal gasification is used in the energy producing industry and increasingly frequently also in the petrochemical industry. To date synthesis gas has been channeled off as an energy carrier for the grinding—drying process, which, with consumptions of between 10 and 30 MW (approx. 3300 m³_{N}/h to 11,000 m³_{N}/h, calorific value: approximately 11,000 kJ/m³_{N}) represents a considerable loss for the actual application. The inventive use of a portion of the coal dust produced for the hot gas generation is thus advantageous from an economic viewpoint.

In the steel and smelting industry the blast furnace gas is used increasingly frequently in power stations for power generation built specifically for this purpose. Accordingly the use of the self produced coal dust can also be advantageously applied in this branch of industry for hot gas generation.

The inventive use of a part of the produced coal dust with the aid of the additional classifier and the supply and feed means of the fluidised fines portion to the carbon burner of the hot gas generator is associated with a significant increase in the degree of efficiency in comparison with the relatively low investments required.

The invention is explained in further detail below by reference to a single drawing, which shows:
an inventive installation for carrying out the inventive method by reference to the example of the production of coal dust for briquette production.

The coal grinding in inert operation takes place in a mill 5 which is a hammer mill in this example. Wet, previously broken-up coal reaches this mill 5 via a conveying means 1 with magnetic separators, a breeches chute 2 and a bunker 3 with screw conveyor base 4 which simultaneously acts as a dosing means. The wet raw coal supplied can have a temperature in the range of from approximately −20° C. to approximately +20° C. and a moisture in the range of from 10% to 75%.

In order to realise the grinding—drying process in the mill 5 hot gases 8 are fed from a hot gas generator 12 with a temperature of approximately 450° C. to the mill 5. By means of a pipeline 13 the coal dust—gas mixture is fed from the mill 5 to a separating unit 6 which is a bag filter in this embodiment. The coal dust 14 separated from the drying and carrier gases reaches a conveying means 7, for example a discharge screw conveyor, and is fed for further processing in a briquetting press (not shown).

A partial flow 15 of the ground product, that is to say of the coal dust 14 from the separating unit 6, is channeled off in order to separate from it a coal dust portion which can be used in the hot gas generator 12. The partial flow 15, which has a temperature in the range of from 70° C. to 120° C., passes in a line 18 via a slide valve 16 and a rotary feeder 17 into a classifier 10.

This classifier 10 is a mechanical or respectively static classifier which is suitable for separating a super fines portion 20 from the partial flow 15 of the coal dust 14, which super fines portion 20 can be combusted in the solid fuel burner of the hot gas generator 12. The fineness can be approximately 50% R90 μm to approximately 1% R90 μm.

The super fines portion 20 passes after the classifier 10 into a silo for super fines 9 and from here via a rotary feeder 23 and a dosing unit 22 in a feed line 21 to the hot gas generator 12 or respectively to its solid fuel burner. The coarse grain reaches a conveying means 19 and can be fed together with the coal dust 14 from the separating unit 6 to the briquetting means (not shown).

The process gases 11 separated in the separating unit 6 are fed to the hot gas generator 12 at least proportionally as return gases 25. The hot gas generator 12 is usefully provided with a (LOMA) perforated jacket combustion chamber and the return gases 25 are heated in this combustion chamber from a temperature of approximately 100° C. to approximately 700° C. and then fed to the mill 5 as a drying and carrier gas.

The whole installation is operated in underpressure. The oxygen content of the inert or reducing drying and carrier gases 8 is maximum 12%. The safety-relevant CO and O₂ values of the process gas within the installation are observed. A proportion of the gases 11 separated in the separating unit 6 is discharged via a flue (not shown) into the environment.

For the start-up process and the shutting-down of the installation and an emergency stop it is necessary to keep the installation inert. The oxygen content in the process gas may not exceed the maximum admissible oxygen threshold concentration of the coal to be respectively prepared.

It is necessary for the inertisation to provide corresponding inertisation gases. The use of CO₂ or nitrogen is usual.

Self-inert grinding installations which as independent coal refining plants are not to be operated as part of a composite installation and for example do not have nitrogen available as in the steel and smelting industry from air decomposition installations must provide these gases by additional purchases. This requires storage capacities and separate equipment, which is a burden on the economy of the process. The required volume flows of inert gas are considerable (several 100 m³/h according to installation size). For normal operation an inert gas production can be integrated into the whole process.

Boiler installations operated with oil or gas are suitable for example, of which the heat can serve for heating purposes of buildings and for hot water preparation. The waste gas arising here has an O₂ content of 1 to 2% and is thus highly suited for the inertisation of the installation in the start-up process and for shutting down as well as for emergency stops. The necessary redundancy can be achieved via CO₂ in banks of cylinders.

1-13. (canceled)

14. Method for coal grinding in inert operation or in non-inert operation, wherein a grinding—drying process of the raw coal supplied is carried out in an air swept mill, wherein hot gases are supplied from a hot gas generator, subsequently the mixture of coal dust and gas is separated in a separating unit and the coal dust is supplied for the use intended or further processing, while the gas is fed back at least proportionally as return gas to the hot gas generator,
characterised in that
the coal dust is fed from the separating unit in full or in part to a classifier and super fines are separated from the coal dust in the classifier, the super fines are supplied in full or in part to the hot gas generator for combustion and heating of the return gases and the hot gases are fed again from the hot gas generator to the mill for the grinding—drying process.

15. Method according to claim 1,
characterised in that
the classification process in the classifier is decoupled from the gas conveying process.

16. Method according to claim 1,
characterised in that
the super fines are separated for combustion in the hot gas generator in a classifier which is formed as a static or mechanical classifier.

17. Method according to claim 1,
characterised in that
super fines with a particle size in the range of from approximately 50% R90 μm to approximately 1% R90 μm are separated in the classifier.

18. Method according to claim 1,
characterised in that
super fines with a particle size of approximately 10% R90 μm are separated in the classifier.

19. Method according to claim 1,
characterised in that
the super fines separated in the classifier are fed in fluidised form to the solid fuel burner of the hot gas generator.

20. Method according to claim 1,
characterised in that
the super fines are supplied from the classifier to a silo for super fines and from this via a rotary feeder and a dosing unit in a feed line in fluidised form to the hot gas generator.

21. Method according to claim 1,
characterised in that
coarse grain of the coal dust arising in the classifier is fed to a conveying means and combined with the coal dust from the separating unit.

22. Installation for coal grinding in inert operation or in non-inert operation,
having a mill for carrying out a grinding—drying process and producing coal dust, a separating unit for separating the coal dust from the gas and a hot gas generator with solid fuel burner for heating the return gases and supply as a hot gas into the mill,
characterised in that
a classifier for separation of super fines from the coal dust and a silo for super fines for receiving the separated super fines are arranged after the separating unit and
the silo for super fines is connected to a solid fuel burner of the hot gas generator through a supply line with a removal means and a dosing means for supplying the separated, fluidised super fines.

23. Installation according to claim 9,
characterised in that
the classifier is a mechanical or static classifier without a secondary gas circuit and is formed in such a way that the optimal working region lies in the granulation region of the super fines portion of the coal dust for the solid fuel burner of the hot gas generator.

24. Installation according to claim 9,
characterised in that
the mill for the grinding—drying process is an air swept mill, for example a vertical roller mill, pendulum roller mill, hammer mill or ring roller mill.

25. Installation according to claim 9,
characterised in that
the separating unit is a filter, for example a bag filter, or a cyclone or a cyclone battery, and a slide valve and a rotary feeder are arranged for supplying a predefinable proportion of the coal dust in a line between the separating unit and the classifier.

26. Installation according to claim 9,
characterised in that
disposed after the separating unit is a conveying means for transporting the coal dust for the intended use, for example to a PCI installation, for coal gasification or briquetting.
